(19) United States
(12) Patent Application Publication
(10) Pub. No.: US 2010/0217879 A1
(43) Pub. Date: Aug. 26, 2010

(54) SYSTEMS AND METHODS FOR REMOTE ACCESS TO INCIDENT DATA

(76) Inventor: Michael M. Weiner, Simi Valley, CA (US)

Correspondence Address: MICHAEL BLAINE BROOKS, P.C., P.O. BOX 1630, SIMI VALLEY, CA, 93062-1630, US

(21) Appl. No.: 12/776,176

(22) Filed: May 7, 2010

Related U.S. Application Data
(63) Continuation-in-part of application No. PCT/US2008/079221, filed on Oct. 8, 2008.
(60) Provisional application No. 60/987,995, filed on Nov. 14, 2007.

(51) Int. Cl. G06F 15/16

(52) U.S. Cl. 709/228; 709/227

(57) ABSTRACT

Systems, devices, and methods for acquisition, processing and display of data from devices, associated with geo-locations.

### CROSS-REFERENCE TO RELATED APPLICATIONS

This application is a continuation-in-part of International Application No. PCT/US2008/079221 filed Oct. 8, 2008, which claims the benefit of U.S. Provisional Application No. 60/987,995, filed, Nov. 14, 2007, the disclosures of which are incorporated herein by reference in their entirety.

### FIELD OF ENDEAVOR

The invention relates to the field of emergency response data gathering and dissemination. In particular, the invention, in its several embodiments relates systems and methods for acquisition, processing and display of data from devices e.g., devices carried and/or deployed by emergency response personnel at a hazardous materials (Hazmat) incident site.

### BACKGROUND

The use of portable wireless sensors and other data collection devices by emergency response agencies is becoming increasingly popular. Such devices include chemical, biological and radiological sensors, video and still picture capture devices, devices for two-way audio communications and global positioning system (GPS) locators. These devices are brought to an incident site by specially equipped vehicles and hand-carried about the site by personnel in protective gear. Robotic vehicles have also been used as carriers of the devices. The primary function of this equipment is to provide real-time information to local incident commanders who are distant from the immediate threat posed by a hazardous substance or environment.

With the advent of wide-area networks such as the Internet, it has become possible to transmit data collected at such an incident site to other agencies in addition to the local incident commander. This makes it possible for remote subject matter experts and regional decision makers to obtain greater immediacy and situational awareness of an emergency situation enabling them to lend their expertise and guidance in mitigation efforts.

There is presently no central agency that ensures that the hardware and systems employed by emergency response agencies in their own jurisdictions are interoperable with those of other jurisdictions. A governmental agency interested in events occurring across several jurisdictions may have to traverse a network of diverse hardware and software systems and organizations to gain access to the same information that is available to incident commanders. More often than not, the flow of information is limited to verbal or electronic messages that are limited in content and subject to delays in transmission.

### SUMMARY

This invention relates to the field of emergency response data gathering and dissemination. In particular, systems and methods for acquisition, processing and display of data from devices e.g., devices carried and/or deployed by emergency response personnel at a hazardous materials (Hazmat) incident site. Such devices may include but not be limited to chemical, biological or radiological measuring instruments, audio/video capture devices, Global Positioning Satellite System (GPSS) based location sensing devices, and voice communication devices. The exemplary system includes a computing structure that ensures interoperability between various hardware and software systems employed by local jurisdictions such as cities and counties so that data from widely scattered incidents is uniformly presented to a wider audience that may include local, state, national and international areas or regions.

The system embodied by this invention circumvents the problem above by providing a common platform for gathering, processing and disseminating information from incident sites and by providing a uniform method for accessing and viewing detailed, real-time information from these incidents.

A particular concern addressed by the system is that data collected from various incidents may be stored on separate and distinct servers owned and operated by independent local jurisdictions such as cities and counties.

DEFINITION OF TERMS (TABLE):

| | |
|---|---|
| Data Source | A device that uploads a stream of data to a server process by means |
| | of a network connection |
| Data Session | A grouping of data from a Data Source that is marked with a starting |
| | and ending time and a starting geo-location |
| Geo-location | A specific location on the Earth marked with a latitude and longitude |
| | value |
| GPS | (Global Positioning System) A system of orbiting satellites that |
| | enable a device on the ground or in the air to accurately determine its |
| | geo-location |
| GUID | A globally unique identifier such as a 48-byte binary number that is |
| | randomly generated and produces a negligible chance of finding a |
| | duplicate within a large grouping of such numbers |
| Incident | An event (such as a call to an Emergency Response System) that is |
| | marked with a particular Geo-location, a Starting Date and Time and |
| | that has a finite duration. |
| GIS | (Geographic Information System) A system that depicts roadways |
| | and localities on a map-based display. Such a system is usually |
| | equipped with pan and zoom capability. |
| Session Marker | A graphic symbol or icon that is superimposed on a GIS display to |
| | indicate the presence of a data session and the current location of its |
| | Data Source. |
| Web Server | A program, which allows Web browsers to retrieve files and other |
| | information from computers connected to the Internet; also a |
| | computer that accepts Web Browsers as clients. |
| Web Browser | A client program that initiates requests to a Web server and displays |
| | the information that the server returns |
| Web Page | A document containing text and graphics that can be accessed |
| | through a web browser on the internet. |

The invention may be embodied in devices, systems of devices, as machine enabled processes and subprocesses. For example, a server of the present invention may comprise a central processing unit and addressable member, where the central processing unit is configured to establish one or more data sessions with one or more data sources, wherein each data session is associated with a unique identifier and each data session is associated with a specific source with a geo-location; and wherein the server is configured to output data of the associated data sessions. In another example, a client of the present invention may comprise a central processing unit and addressable member where the central processing unit is configured to receive session data associated with a unique identifier for a data source and is configured to receive session data associated with a specific source and a geo-location associated with the session data set; and wherein the client is further configured to display within a geographic information system one or more session data sets based on the geo-location associated with each data session set. Accordingly, a system embodiment of the present invention may comprise: (a) a first processing node comprising a central processing unit and addressable member, where the central processing unit of the first processing node is configured to establish one or more data sessions with one or more data sources, and where each data session is associated with a unique identifier and each data session is associated with a specific source with a geo-location; and (b) a second processing node in networked communication with the first processing node, the second processing node comprising a central processing unit and addressable member where the central processing unit of the second processing node is configured to display within a geographic information system the session data from the first processing node based on the geo-location associated with the data session.

A process embodiment may be configured in a device, or system of devices. Accordingly, a machine-enabled method of accessing integrated remote incident data comprising (not necessarily in the following order): (a) establishing one or more data sessions with one or more data sources; (b) associating each data session with a unique identifier; (c) associating each data session with a geo-location; and (d) displaying within a geographic information system the session data from the second processing node based on the geo-location associated with the data session.

### BRIEF DESCRIPTION OF THE DRAWINGS

Embodiments of the present invention are illustrated by way of example and not limitation in the figures of the accompanying drawings, and in which:

FIG. 1 is an exemplary top level system embodiment block diagram of the present invention;

FIG. 2A is an exemplary server embodiment of the present invention;

FIG. 2B is an exemplary server embodiment of the present invention;

FIG. 3 is a flowchart of a portion of an exemplary process embodiment of the present invention;

FIG. 4 is a flowchart of a portion of an exemplary process embodiment of the present invention;

FIG. 5 is a flowchart of a portion of an exemplary process embodiment of the present invention; and

FIG. 6 is a flowchart of a portion of an exemplary process embodiment of the present invention.

### DETAILED DESCRIPTION OF THE INVENTION

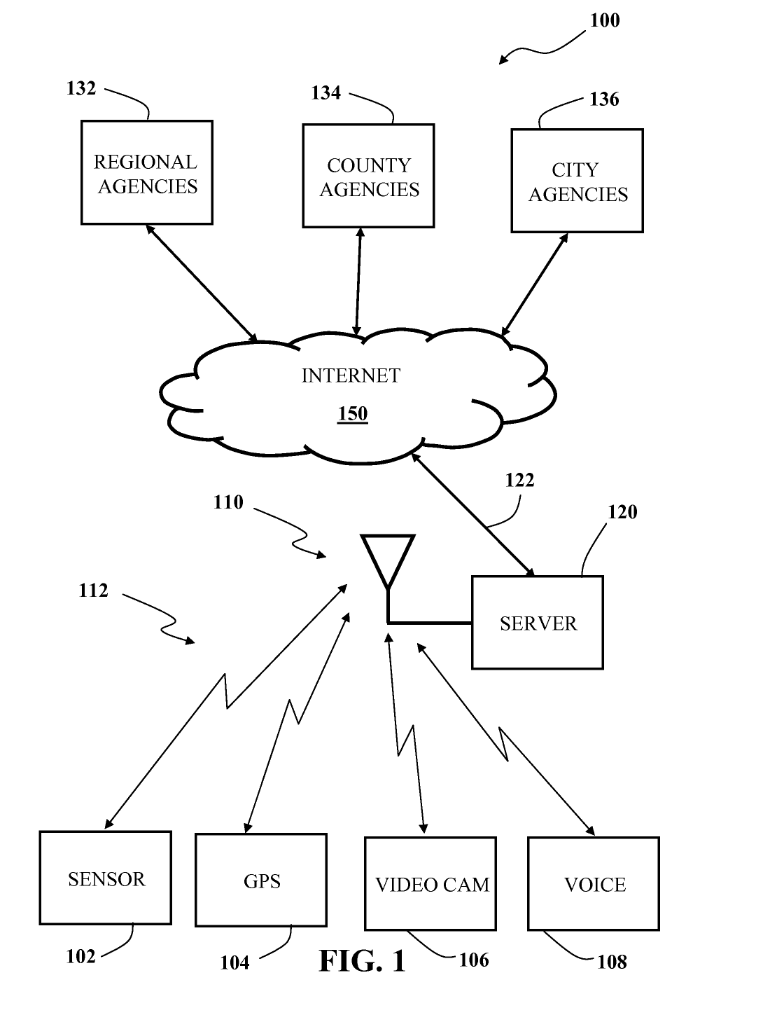

FIG. 1 illustrates an exemplary system embodiment 100 of the present invention where one or more sensors 102, GPS devices 104, video recording devices 106 or cameras, and sound recording devices or microphones 108, may be in collective communication, e.g., wireless communication 110, with one or more servers 120 for integrating the information streams from the field. FIG. 1 also illustrates receiving stations, i.e., clients, such as regional governmental agency devices 132, county agency devices 134, and city agency devices 136. For example, via a network link 122 and the internet 150, the server 120 may provide information 112 from one or more remote sites, such as a field site, in an integrated fashion to one or more client agencies.

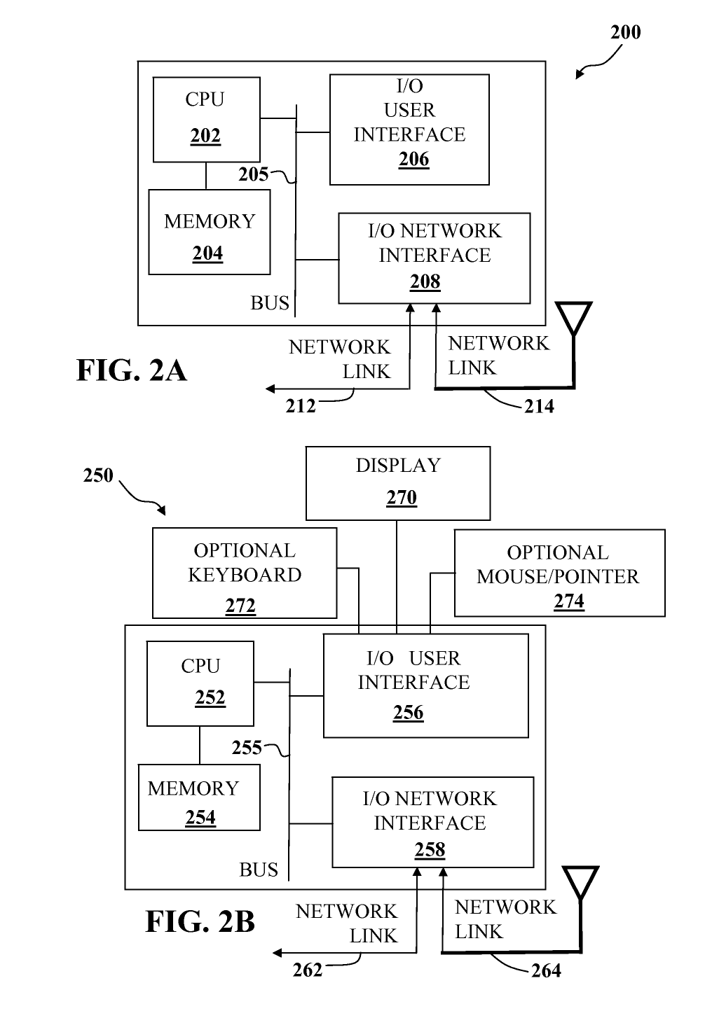

FIG. 2A illustrates an exemplary computing device 200 that may host a server embodiment of the present invention. The computing device has a central processing unit (CPU) 202 and addressable memory 204. The CPU 202 may be in operable communication, via a bus 205, for example, with other components of the computing device such as an optional input/output user interface 206 and an input/output network interface 208 where a network link 212 may be used in a network to put the server in operable communication with the clients, such as the agencies of FIG. 1. An additional network link 214 may be a wireless network link that may be used to put the server in operable communication with the clients, such as the agencies of FIG. 1.

FIG. 2B illustrates an exemplary computing device 250 that may host a client embodiment of the present invention. The computing device has a CPU 252 and addressable memory 254. The CPU 252 may be in operable communication, via a bus 255, for example, with other components of the computing device, such as an input/output user interface 256 and an input/output network interface 258 where a network link 262 may be used in a network to put the client in operable communication with a server, such as the server of FIG. 1. An additional network link 264 may be a wireless network link that may be used to put the client in operable communication with a server, such as the server of FIG. 1. Connected to the I/O user interface 256 is shown a display 270 which may be a touch screen. An optional keyboard 272 may be connected to the I/O user interface 256. In addition, an optional mouse 274 or other display pointing device may be connected to the I/O user interface 256.

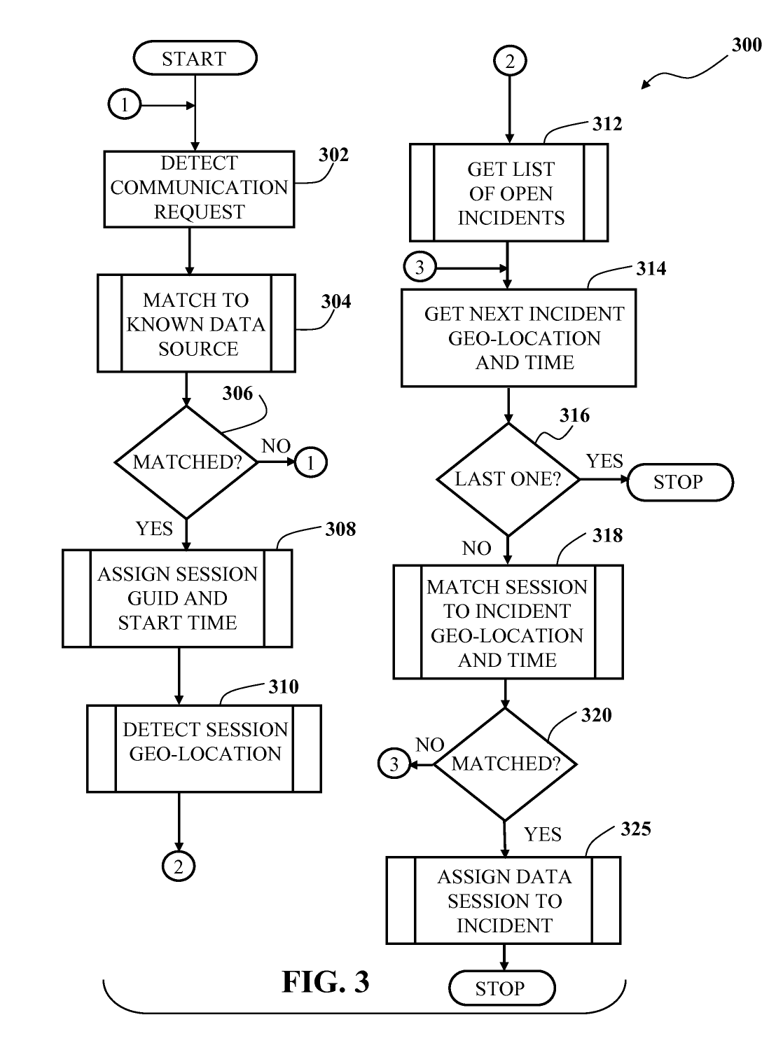

Machine-executable instructions may be loaded at the server, that when executed, perform steps of attributing incoming data to an existing tracked incident and if not yet attributable to an existing tracked incident, opening a new incident file with which to associate the incoming data. FIG. 3 is a top-level flowchart 300 example of the subprocess of assigning data of a data session to an incident. In this example, the server may detect a communication request (step 302) having a source identifier and initiate a subprocess (step 304) of attempting to match the source identifier with an entry in a table or database of known or registered data sources. If matched (test 306), the server may assign a session globally unique identifier (GUID) (step 308) such as a randomly generated 48-byte binary number. Also if matched (test 306), the server may initiate a subprocess to detect a geo-location for the data source and associate the geo-location with the source (step 310). The server may get a list of open incidents (step 312), for example, hazardous material spills. In a process of matching the present data session with a geo-location and time, the server may get the next incident geo-location and time (step 314), and if not, the last one of the list (test 316), match the session to the incident geo-location and time (step 318) from the list. If the data session is matched (test 320) to the incident geo-location and time, then the data session may be assigned to the incident (step 325).

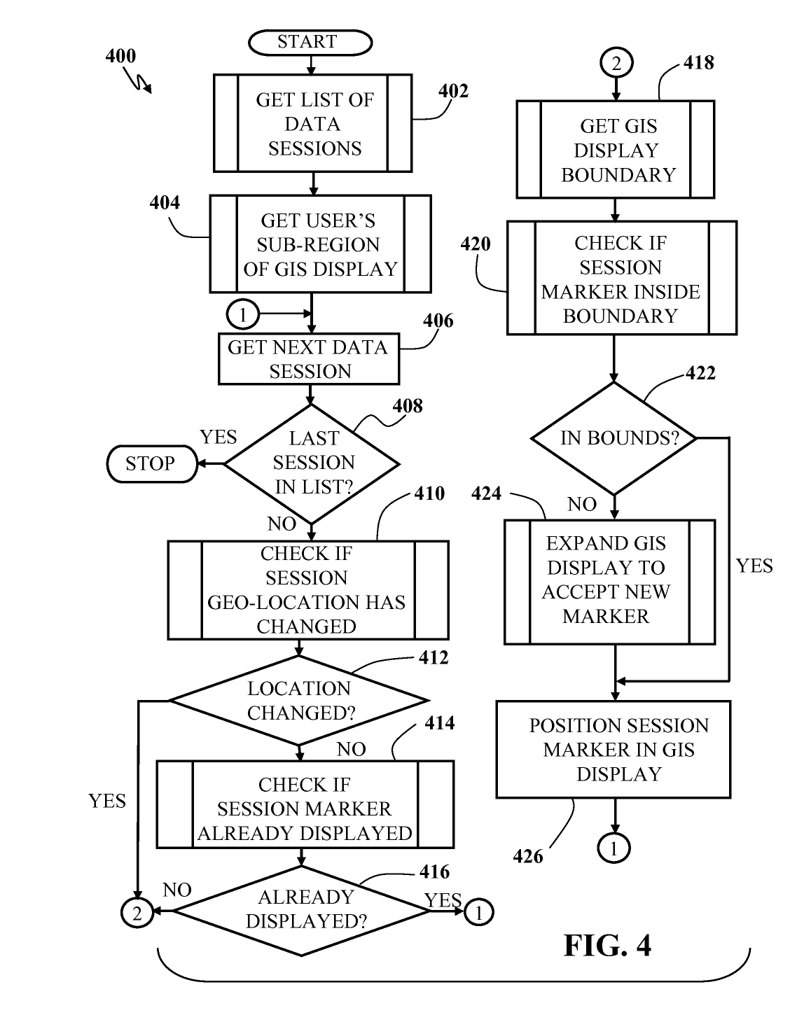

Machine-executable instructions may be loaded at the client, that when executed, perform steps of positioning a session marker in the context of a geographic information system for display. A system that depicts roadways and localities on a map-based display, such as a Geographic Information System (GIS) may be displayed in whole or in part at a client display for a user agency (for example). FIG. 4 is a top-level flowchart 400 example of the subprocess of positioning a session marker in the context of a geographic information system for display. The client may get a list of data sessions (step 402) and get the user's sub-region of the total GIS display (step 404). The data of each data session may be queried or gotten (step 406) until all data sessions that comprise the list (test 408) are accessed. The client may check whether the session geo-location for each data session has changed (step 410). If the geo-location for a particular data session has not changed (test 412), then the client may determine whether a session marker representing the data session is presently displayed (step 414) and if presently display (test 416), the client may get the next session data (step 406) from the list of data sessions. For scenarios where either the geo-location has changed (test 412) or the session marker is not already displayed (test 416), the client may get the GIS display boundary (step 418) and determine whether the session marker is relative to the GIS display boundary (step 420). If the session marker is determined as being within the bounds of the GIS display (test 422 ‘yes” branch), the client may position the session marker within the GIS display (step 426). If the session marker is determined as being outside of the bounds of the GIS display (test 422 “no” branch), the client expands the display boundary of the GIS display (step 424) in order to accept and position the display session marker in the GIS display (step 426). Thereafter, the client may get the next data session (step 406) from the list of data sessions.

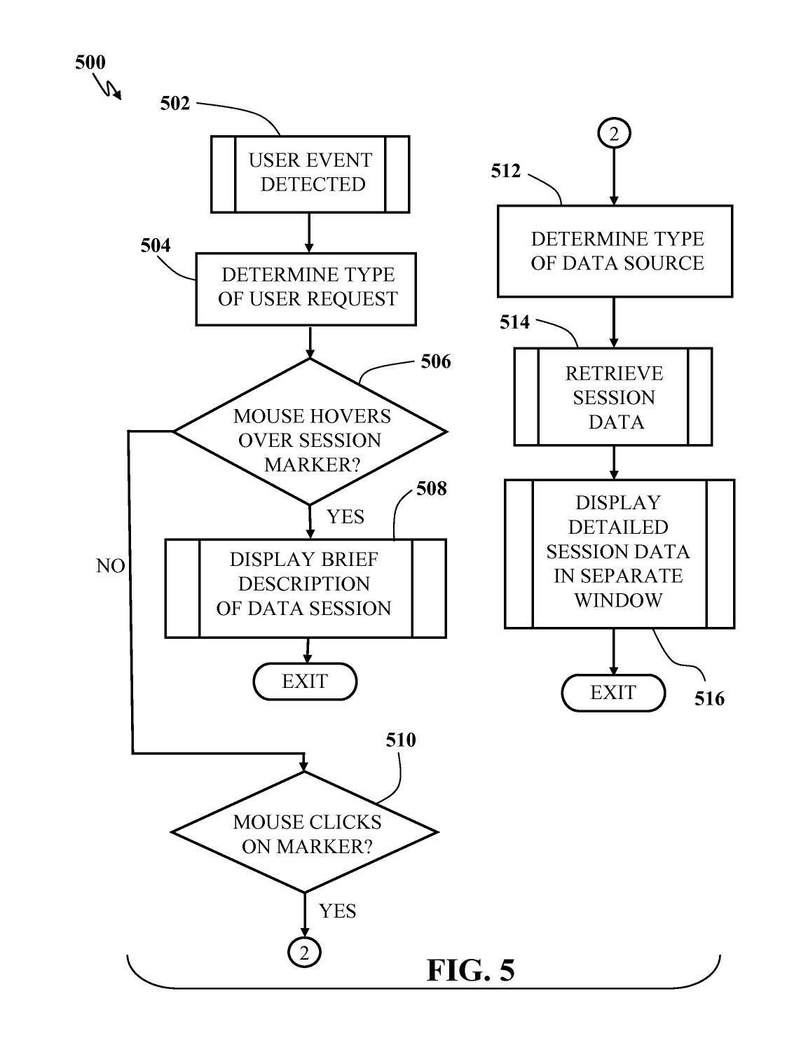

Machine-executable instructions may be loaded at the client, that when executed, perform steps of retrieving session data to a display based on point and click. FIG. 5 is a top-level flowchart 500 example of the subprocess of retrieving session data to a display based on point and click. The client may detect a user event (step 502) such as a keyboard entry, a click, an auditory announcement, or a touch screen contact. The client may determine the type of user request (step 504) based, for example, on the characteristics of the event. The client may time the proximity of a display pointer such as a mouse pointer to the graphic display of a session marker (test 506). If a hovering threshold, e.g., both a predetermined screen range and time from the session marker are met, the client may display a brief or thumbnail description of the data session associated with the session marker (step 508). If the user inputs a click or other analogous indicative input in conjunction with a pointer, e.g., a mouse pointer, in proximity to a session marker (test 510), the client may determine the type of data source (step 512) associated with the session marker, retrieve the session data (step 514) and may display a detailed version of the session data in a separate window (step 516).

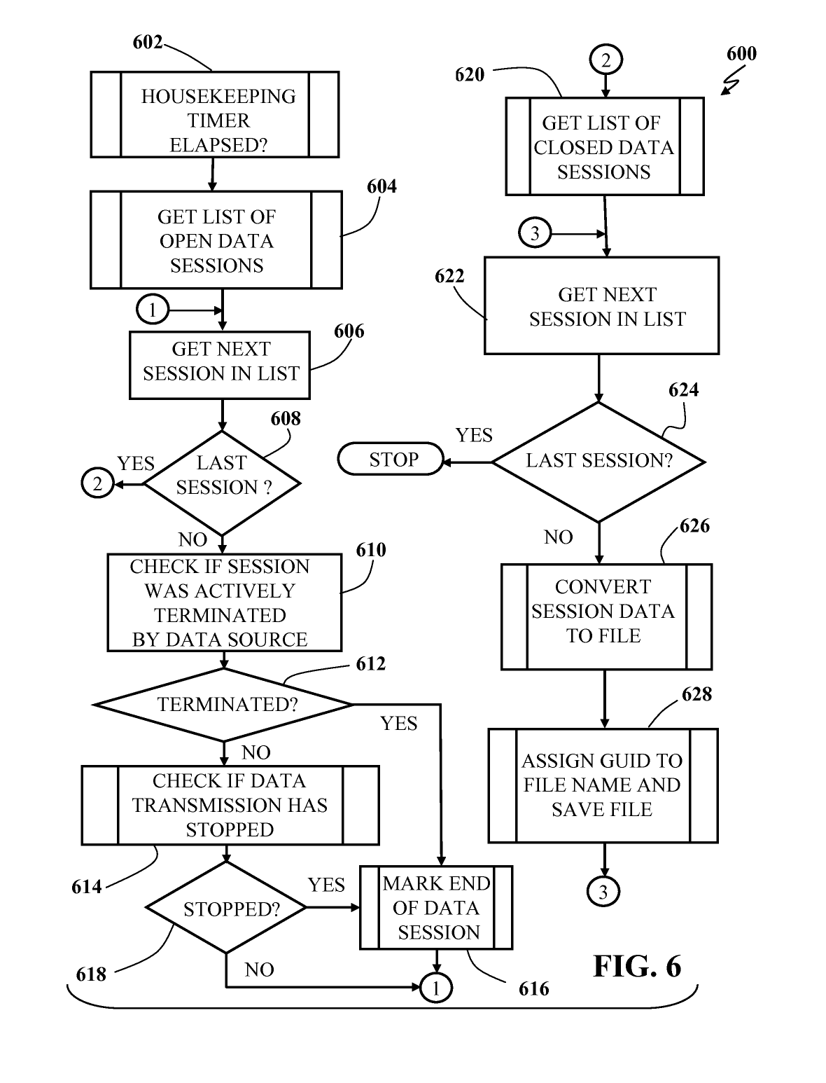

Machine-executable instructions may be loaded at the server, that when executed, perform steps of storing data, if active data sessions, and terminating active data sessions, and retrieving session data to a display based on point and click. FIG. 6 is a top-level flowchart 600 example of the subprocess of storing data, if active data sessions, and terminating active data sessions and retrieving session data to a display based on point and click. The server may determine whether a housekeeping timer has elapsed (step 602) and if so, the server may get a list of open data sessions (604). The server is to get each data session in the list (step 606) and test and if not the last session of the list (test 608), then the server determines whether the data session is actively terminated by its associated data source (step 610) and, if so (test 612 “yes” branch), the server may mark an end of the particular data session (step 616). If the data session was not actively terminated by the associated data source (test 612), then the server may determine whether the data transmission from the particular data source has stopped (step 614), e.g., based on an inactivity time threshold. If the data transmission from the particular data source has stopped (test 618), the server may mark an end of the particular data session (step 616). Otherwise, the server may get the next data session of the list (step 606). Once the members of the data session list are queried (test 608), the server may get a list of closed data sessions (step 620). For each closed session of the closed data session list (step 622), the server may convert the session data to a file (step 626) and may assign a GUID to the file and store or archive the file (step 628). Once the last member of the list of closed data sessions (test 624) is converted to a file (step 626) and associated with a GUID (step 628), the exemplary housekeeping or archiving subprocess may end.

Accordingly, a system embodiment for communicating information from a site, such as an emergency response site, may comprise: (a) a server that incorporates a processing unit configured to monitor, via a packet transmission network, and process requests having data content originating from a plurality of data content sources, wherein data content may comprise a measuring instrument output or a multi-media stream and a geo-location associated with each content source; and (b) a processing module having an addressable memory, where the processing module is configured, by circuitry, executing machine-readable instructions, or combinations of both, to execute the step of reformatting as shown by example in the flowchart form at FIG. 3, and/or by the following exemplary pseudo-code:

```
Extract unique Data Source identification code from the data
      content;
If the Data Source identification code matches an entry in
      database:
  Generate GUID and create an entry in the database for a new
        Data Session;
  Assign the starting geo-location to the Data Session;
  Obtain list (L) active incidents from the database that includes
        geo-location and time for each incident;
      For each incident in list (L):
      Calculate distance (A) between geo-locations of Data
          Session and Incident;
        Calculate time difference (B) between start time of
          Session and start time Incident;
        If quantities A and B are within prescribed bounds:
        Assign Data Session to Incident;
        Exit if;
      End for;
    End for;
End if;
```

(c) a display unit configured to integrate the geo-location associated with the measuring instrument with a Geographic Information System (GIS) display format that includes superimposing on the display iconic markers indicating the location of data sources and that also includes means for excluding those markers from the display as shown by the example in flowchart form at FIG. 4 and/or by the following exemplary pseudo-code:

```
Obtain list (L) of all active Data Sessions;
Obtain a bounded sub-region (R) of the GIS display that is allocated to
  the current display user;
  For each entry in list L:
    If the Data Session Marker is not already shown on the display:
      If the geo-location of Data Session is inside the region R:
        Superimpose on the GIS display an appropriate Session;
      Marker at the current geo-location of the Data Session;
    Expand the bounds of the GIS display to include the additional
          geo-location if needed;
      End if;
    End if;
  End for;
```

(d) a processing module having an addressable memory, where the processing module is configured, by circuitry, executing machine-readable instructions, or combinations of both, to execute the step of responding to user request events as shown by the example in flowchart form at FIG. 5 and/or by the following exemplary pseudo-code:

```
Determine nature of user-initiated event;
If the event is rolling or placing the mouse over a Session Marker:
  Display a summary description of the Data Session;
Else if the event is clicking the mouse over a Session Marker:
  Determine the underlying Data Source;
  Prepare an auxiliary window or separate display area that
    conveys Data Session information in a manner consistent with
    the type of Data Source;
End if;
```

and (e) a processing module having an addressable memory, where the processing module is configured, by circuitry, executing machine-readable instructions, or combinations of both, to execute the step of classifying and storing the content of data sessions as shown by the example in flowchart form at FIG. 6 and/or by the following exemplary pseudo-code:

```
Determine if a timer interval has expired requiring activation of
  housekeeping Function;
  If housekeeping function is activated:
    Obtain a list (L) of open Data Sessions (no entry in Date Closed
    attribute);
    For each entry in list L:
      If the Data Source has transmitted no data for a preset period of
time;
        Mark session closed in database;
      End if;
    End for;
    Obtain a list (M) of closed Data Sessions;
    For each entry in list M:
      If the Data Source is a measuring instrument:
        Convert session data to a persistent format;
        Assign the Data Session GUID to the file name and
        archive;
      Else if the Data Source is a multimedia stream:
        Convert the session data to a storable format such as
          MP3 or MPEG4;
        Assign the Data Session GUID to the file name and
        archive;
      End if;
    End for;
  End if;
```

### Variations

Many variations are possible both in the configuration of the system embodiments and in the order and distributed execution of the steps of the embodiments of the present invention. In view of the foregoing, it should be understood that the present invention may be implemented in a variety of alternative ways using a variety of alternative processing methods, and that all such implementations and processing methods are deemed to be within the scope of the present invention. For example, the invention is applicable to monitoring of shipyards, refineries and power plants where incidents could be triggered automatically by some measuring device, monitoring campus incidents where key personnel carry audio/video capture and communications devices, and monitoring the safety of isolated workers who carry instruments that warn them of toxic substances or explosive mixtures. Accordingly, many alterations and modifications, including combinations and subcombinations of steps and/or elements of various embodiments of the present invention, may be made by those having ordinary skill in the art without departing from the spirit and scope of the invention. Therefore, it must be understood that the illustrated embodiments have been set forth only for the purposes of example and that it should not be taken as limiting the invention as defined by the following claims.

What is claimed is:

1. A system comprising:
a first processing node comprising a central processing unit and addressable member, wherein the central processing unit of the first processing node is configured to establish one or more data sessions with one or more data sources, wherein each data session is associated with a globally unique identifier and each data session is associated with a specific source with a geo-location; and
a second processing node in networked communication with the first processing node, the second processing node comprising a central processing unit and addressable member wherein the central processing unit of the second processing node is configured to display within a geographic information system the session data from the first processing node based on the geo-location associated with the data session.

2. The system of claim 1 wherein the central processing unit of the first processing node is further configured to assign a globally unique identifier to each data source based on a minimal negligible probability of duplicating an identifier of a data source by a third processing node.

3. The system of claim 1 wherein the central processing unit of the first processing node is further configured to aggregate collections of data sources and data sessions from other servers located within a designated geographical area.

4. The system of claim 1 wherein the central processing unit of the first processing node is further configured to:
determine a time of a data session;
determine a geo-location of a data session; and
determine if a data session merits designation as an incident, and if so, store the determined time and determined geo-location in an incident collection.

5. The system of claim 1 wherein the central processing unit of the first processing node is further configured to:
determine a time of a data session;
determine a geo-location of a data session; and
identify one or more data sessions that fall within a designated time interval and distance from a corresponding time and geo-location of an entry in an incident collection of an incident, and associate the identified one or more sessions with the incident.

6. A server comprising:
a central processing unit and addressable member, wherein the central processing unit is configured to establish one or more data sessions with one or more data sources, wherein each data session is associated with a unique identifier and each data session is associated with a specific source with a geo-location; and wherein the server is configured to output data of the associated data sessions.

7. The server of claim 6 wherein the central processing unit is further configured to assign a globally unique identifier to each data source based on a minimal negligible probability of duplicating an identifier of a data source by a third processing node.

8. The server of claim 6 wherein the central processing unit is further configured to aggregate collections of data sources and data sessions from other servers located within a designated geographical area.

9. The server of claim 6 wherein the central processing unit is further configured to:
determine a time of a data session;
determine a geo-location of a data session; and
determine if a data session merits designation as an incident, and if so, store the determined time and determined geo-location in an incident collection.

10. The server of claim 6 wherein the central processing unit is further configured to:
determine a time of a data session;
determine a geo-location of a data session; and
identify one or more data sessions that fall within a designated time interval and distance from a corresponding time and geo-location of an entry in an incident collection of an incident, and associate the identified one or more sessions with the incident.

11. A client comprising:
a central processing unit and addressable member wherein the central processing unit is configured to receive session data associated with a unique identifier for a data source and is configured to receive session data associated with a specific source and a geo-location associated with the session data set; and wherein the client is further configured to display within a geographic information system one or more session data sets based on the geo-location associated with each data session set.

12. The client of claim 11 wherein the central processing unit if further configured to aggregate collections of data sources and data sessions from other servers located within a designated geographical area.

13. A method of accessing integrated remote incident data comprising:
establishing, by a first processing node, one or more data sessions with one or more data sources;
associating, by the first processing node, each data session with a unique identifier;
associating, by the first processing node, each data session with a geo-location; and
displaying, by the second processing node and within a geographic information system the session, data from the first processing node based on the geo-location associated with the data session.

14. The method of claim 13 further comprising assigning, by the first processing node, a globally unique identifier to each data source based on a minimal negligible probability of duplicating an identifier of a data source by a third processing node.

15. The method of claim 13 further comprising aggregating, by the first processing node, collections of data sources and data sessions from other processing nodes located within a designated geographical area.

16. The method of claim 13 further comprising:
determining, by the first processing node, a time of a data session;
determining, by the first processing node, a geo-location of a data session; and
determining, by the first processing node, whether a data session merits designation as an incident, and if so, storing the determined time and determined geo-location in an incident collection.

17. The method of claim 13 further comprising:
determining, by the first processing node, a time of a data session;
determining, by the first processing node, a geo-location of a data session; and
identifying, by the first processing node, one or more data sessions that fall within a designated time interval and distance from a corresponding time and geo-location of an entry in an incident collection of an incident, and associating the identified one or more sessions with the incident.
